(19) United States
(12) Patent Application Publication
(10) Pub. No.: US 2010/0007494 A1
(43) Pub. Date: Jan. 14, 2010

(54) A SECURITY ALARM DEVICE

(75) Inventors: Vitaly Petrovich Lenshin, Moscow (RU); Evgeny Ivanovich Voronin, Balashikha (RU); Sergey Georgievich Rikhter, Moscow (RU)

Correspondence Address: PATENTTM.US, P. O. BOX 82788, PORTLAND, OR, 97282-0788, US

(73) Assignee: ZAKRYTOE AKTSIONERNOE OBSCHESTVO 'KASISS', Moscow (RU)

(21) Appl. No.: 12/374,607

(22) PCT Filed: Aug. 1, 2006
(86) PCT No.: PCT/RU06/00406

§ 371 Date: Jan. 21, 2009

(51) Int. Cl. G08B 13/14

(52) U.S. Cl. 340/568.1

(57) ABSTRACT

The invention relates to security alarm devices and can be used for warning about the modification of the position of monitored objects with respect to a user monitoring said objects. The inventive device comprises an object device which is arranged on each guarded object and is used for inquiring and emitting a signal about the presence of a corresponding object device in a monitored area, a control system used for switching on an alarm device and an information display device.

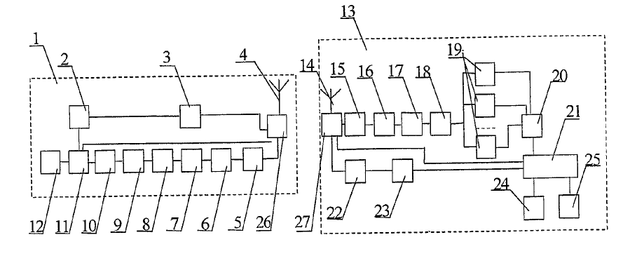

### FIELD OF THE INVENTION

The present invention relates to security alarm devices and may be used for warning about changes in positions of monitored objects relative to a user monitoring thereof.

### PRIOR ART

A broadband security alarm device on the basis of a spread-spectrum signal (SSS) is known, which includes an object device arranged at each protected object and comprises: a pseudorandom sequence generator, a generator-shaper of spread-spectrum signals, a power amplifier, and a transmitting antenna, a user's device being at the user, comprising a receiving antenna, an input circuit for filtering and matching, a bandpass amplifier that are all connected in series, N units that are connected in parallel for optimal processing of SSS on surface acoustic waves, a solver with a control circuit, and an alarm system unit with a visualization device (liquid-crystal display), wherein the transmitting portion and the receiving portion have the same signal carrying frequency (RU 2234135, G 08 B 13/14). This device is the closest technical analogue to the claimed device.

It is supposed that efficient use of such an alarm device provides simultaneous protection of several objects. Since several (more than two) simultaneously operating transmitters create significant mutual effects, the known device has insufficient interference immunity, which results in false actions and other errors. Reliability of an alarm device operating at a constant signal carrying frequency may be also lowered due to false actions caused by signal interference at the receiver input when radio waves are reflected from building walls or other obstacles.

### BRIEF DESCRIPTION OF THE INVENTION

The objective of this invention is to improve functioning reliability of an alarm device.

The stated objective is achieved owing to the fact that the claimed security alarm device includes an object device arranged at each protected object and comprising: a generator-shaper of coded signals, a power amplifier, and an antenna; a user's device being at the user, comprising an antenna, an input matching circuit, an input bandpass filter, an amplifier, a bandpass filter, the latter comprising an N-channel selector for selecting signals on presence of object devices, a solver adapted for polling object devices and issuing a signal about presence of a corresponding object device within a monitored area, a control circuit intended for switching the alarm device on, and a device for visualizing information, that are all connected in series, the said user's device additionally comprising an antenna switch with two signal inputs and one control input, connected in series: a generator-shaper of coded signals, which is connected to the control circuit additionally intended for cyclic issuance of a command for forming a coded signal-request to the said generator-shaper, and a power amplifier connected to one of the antenna switch signal inputs, a matching input circuit being connected to the other of the antenna switch signal inputs, the control input at the user's device antenna switch is connected to the said control circuit, the object device further comprises an antenna switch with two signal inputs and one control input, the input matching circuit of the object device being connected to the first signal input and the power amplifier being connected to the second signal input, and also comprises an input bandpass filter, a signal amplifier, a bandpass filter, a selector for identifying a received signal, a solver for making a decision on presence of a corresponding signal, a control circuit for cyclically putting the antenna switch into the signal transmission mode or the signal reception mode, switching a generator-shaper of coded signals from the object device into the emission mode, and for turning a sound alarm on, which are all connected in series, the control input of the object device antenna switch being connected to its control circuit.

The stated objective is further achieved owing to the fact that each channel of the selector comprises a demodulator and a number filter, the latter being matched with a code of the corresponding object device generator-shaper, which are connected in series.

The stated objective is also achieved owing to the fact that the antennas of the user's device and the object device are transmitting-receiving antennas.

The stated objective is also achieved owing to the fact that the generator-shaper of each object device and the generator-shaper of the user's device operate in the hopping mode, the doubled maximum frequency deviation from the rated value not exceeding the pass band of the filtering system for the object devices and the user's device.

### BRIEF DESCRIPTION OF THE DRAWINGS

The invention is explained in the drawings where:

1—the object device;

2—the generator-shaper of the object device;

3—the object device power amplifier;

4—the object device antenna;

5—the input matching circuit of the object device;

6—the input bandpass filter of the object device;

7—the object device signal amplifier;

8—the object device bandpass filter;

9—the object device selector;

10—the object device solver;

11—the object device control circuit;

12—the object device sound alarm;

13—the user's device;

14—the user's device antenna;

15—the input matching circuit of the user's device;

16—the input bandpass filter of the user's device;

17—the user's device signal amplifier;

18—the user's device bandpass filter;

19—the user's device selector for N channels;

20—the user's device solver;

21—the user's device control circuit;

22—the user's device power amplifier;

23—the generator-shaper of the user's device signal;

24—the sound alarm of the user's device;

25—the user's device display;

26—the antenna switch of the object device;

27—the antenna switch of the user's device.

Micro-power, small-size object devices 1 (that is, transceivers operating at a set frequency band; the FIGURE shows only one n-object device) are arranged at all N objects. Each of these object devices comprises a generator-shaper 2 of the object device signal; a power amplifier 3 of the object device; an antenna 4 of the object device; an input matching circuit 5 of the object device; an input bandpass filter 6 of the object device; an amplifier 7 of the object device signal; a bandpass filter 8 of the object device; a selector 9 of the object device; a solver 10 of the object device; a control circuit 11 of the object device; a sound alarm 12 of the object device, an antenna switch 26 of the object device.

The generator-shaper 2 is a shaper of a coded signal having the carrier frequency f. Coding is made in accordance with a pseudorandom code which is individual for each object device and is given at the time of manufacturing. A signal that is amplified and filtered in the amplifier 3 is emitted on the air with the use of the antenna 4. The input matching circuit 5 and the input bandpass filter 6 are tuned to a set frequency band. After receipt by the object device this coded signal passes through the input matching circuit 5, the input bandpass filter 6, is amplified in the amplifier 7, additionally filtered in the bandpass filter 8, and comes to the selector 9, after which the solver 10 determines whether a signal is present; the control circuit 11 controls the operation modes of the object device, the sound alarm 12 and the antenna switch 26 of the object device.

Signals from the object devices installed at the monitored objects are received by the user's device 13 being at the user who exercises monitoring. The user's device 13 comprises an antenna 14, an antenna switch 27, an input matching circuit 15, an input bandpass filter 16, a signal amplifier 17, a bandpass filter 18, a selector 19 having N channels, a solver 20, a control circuit 21, a power amplifier 22, a signal generator-shaper 23, a sound alarm 24 and a display 25. The antenna 14, the input matching circuit 15, the input bandpass filter 16 and the bandpass filter 18 are tuned to a set frequency band having the carrier frequency f. Each channel of the selector 19 comprises a demodulator and a numerical filter matched with a pseudorandom sequence modulating a signal of each object device, which are connected in series.

The security alarm device works as follows.

The control circuit 21 of the user's device 13 issues, cyclically and with a set scanning period T_{sc}, the command to shape a signal-request coded with an individual code for a particular n-object device to the generator-shaper [symbol] aeτ 23 of the user's device 13 signal. The signal-request is amplified in the power amplifier 22 of the user's device and emitted on the air by the user's device antenna cyclically switched to the transmission mode by the antenna switch 27 of the user's device with the use of the control circuit 21 of the user's device. In order all the object devices 1, including n-object device, may receive the signal emitted by the user's device 13, the control circuits 11 of the object devices 1 transfer their antenna switches 26 to the reception mode immediately after their start-up.

After receiving a signal-request the selector 9 of n-object device compares the received coded signal with its own individual code, and proceeding from a comparison result the solver 10 of n-object device takes a decision on the presence of a signal, i.e., the received signal is identified as “friend”. From the time of identifying the control circuit 11 of the object device starts counting the time period T_{sc}, transfers the antenna switch 26 of the object device 1 to the transmission mode and emits a reply signal shaped in the signal generator-shaper 2 and amplified in the power amplifier 3 of the object device 1.

The control circuit 21 of the user's device 13 provides for reception of the reply signal from n-object device 1 by regularly switching the antenna switch 27. The received signal is amplified by the amplifier 17 and comes to the selector 19. Thus, when n-reply signal of sufficiently high level (from n-object device 1) is present on the air, a presence signal is formed at the output of matched n-filter of the selector 19. The solver 20, by regularly polling each channel of the selector 19, finds the reply presence signal of n-channel and transmits data on the presence of the object device 1 in the monitored area to the control circuit 21, after which the user's device 13 jumps to the signal-request emission mode for next n+1 object device 1. After polling of all N object devices 1 for the time period T_{sc} is completed, the “request-reply” cycle is repeated.

If a monitored object—n-object device 1—moves away to a distance exceeding a set limit, the level of the reply signal at the output of matched n-filter of the selector 19 of the user's device 13 will become lower than the threshold one. In the result, the control circuit 21 of the user's device 13 will switch the sound alarm 24 on and output information on the lost object to the display 25 of the user's device 13. Simultaneously with it the user's device stops transmitting the signal-request to n-object device 1. Due to this the waiting time for the next signal-request in the period T_{sc} is exceeded, which results in triggering the control circuit 11 of the object device and turning the sound alarm 12 on. It means that the protected object is lost (or stolen).

The security alarm system with transceivers and regular scanning of monitored objects has several advantages over radio communication systems using the object device—transmitter and the user's device—receiver, namely:

high reliability of the claimed device in operation, since, contrary to the closest analogous solution, radio transmitters of object devices go on the air (i.e., are turned on) one by one in accordance with the synchronous algorithm of scan-request at set time intervals, owing to which mutual interference of radio transmitter signals from protected objects is eliminated;

possibility of forming an alarm signal both in the user's device and in the object device 1 (at a protected object), which increases efficiency of the protective function, provides for more operative reaction of a user, which, in the result, should make recovery of a lost thing easier;

possibility of using less robust signals than in the closest analogous solution, e.g., with amplitude manipulation, enables to make the claimed device significantly simpler and cheaper due to using relatively simple and inexpensive devices for digital processing of signals;

possibility of resisting signal interference at the receiver input and, consequently, false actions of the device operating in close quarters (apartments, offices, cars, etc.) due to frequency hopping in generators-shapers of object devices and the user's device.

The claimed device, when implemented, will enable to timely warn a user about possible loss (or theft) of monitored objects, for example valuable personal belongings, including those of relatively small size. A sound alarm at a monitored object, acting when such an object moves away to a set distance, will help locating a lost object operatively. If a third party makes encroachment upon an object, a sudden and sharp sound alarm from the lost object may scare the thief, which, in the result, should preclude the theft.

### INDUSTRIAL APPLICABILITY

The claimed security alarm device may be most successfully applied in the industry for protecting personal belongings of a user against loss or theft.

What is claimed is:

1. A security alarm device including an object device arranged at each protected object and comprising: a generator-shaper of coded signals, a power amplifier, and an antenna; a user's device being at the user, comprising an antenna, an input matching circuit, an input bandpass filter, an amplifier, a bandpass filter comprising an N-channel selector for selecting signals on presence of object devices, a solver adapted for polling object devices and issuing a signal about presence of a corresponding object device within a monitored area, a control circuit intended for switching the alarm device on, and a device for visualizing information, that are all connected in series, characterized in that said user's device additionally comprises an antenna switch with two signal inputs and one control input, connected in series: a generator-shaper of coded signals, which is connected to the control circuit additionally intended for cyclic issuance of a command for shaping a coded signal-request to the said generator-shaper, and a power amplifier connected to one of the antenna switch signal inputs, a matching input circuit being connected to the other of the antenna switch signal inputs, the control input at the user's device antenna switch is connected to the said control circuit, the object device further comprises an antenna switch with two signal inputs and one control input, the input matching circuit of the object device being connected to the first signal input and the power amplifier being connected to the second signal input, and also comprises an input bandpass filter, a signal amplifier, a bandpass filter, a selector for identifying a received signal, a solver for making a decision on presence of a corresponding signal, a control circuit for cyclically putting the antenna switch into the signal transmission mode or the signal reception mode, switching a generator-shaper of coded signals from the object device into the emission mode, and for turning a sound alarm on, which are all connected in series, the control input of the object device antenna switch being connected to its control circuit.

2. A security alarm device according to claim 1, characterized in that each channel of said selector comprises a demodulator and a number filter, the latter being matched with a code of the corresponding object device generator-shaper, which are connected in series.

3. A security alarm device according to claim 1, characterized in that antennas of said user's device and object devices are transmitting-receiving antennas.

4. A security alarm device according to claim 1, characterized in that the generator-shaper of each object device and the generator-shaper of the user's device are made with the possibility of operating in the frequency hopping mode, wherein doubled maximum frequency deviation from the rated value not exceeding the pass band of the filtering system for the object devices and the user's device.
